(19) United States
(12) Patent Application Publication
(10) Pub. No.: US 2023/0270622 A1
(43) Pub. Date: Aug. 31, 2023

(54) RECHARGEABLE AND PORTABLE COMPRESSION DEVICE AND METHOD OF USE

(71) Applicant: REATHLETE LLC, Tallahassee, FL (US)

(72) Inventor: Ziv LEVY, Moshev Ora (IL)

(21) Appl. No.: 17/683,313

(22) Filed: Feb. 28, 2022

(51) Int. Cl. A61H 9/00

(52) U.S. Cl. CPC A61H 9/0078; A61H 2201/5007; A61H 2205/10; A61H 2201/5071; A61H 2201/503; A61H 2209/00; A61H 2201/165

(57) ABSTRACT

The current invention relates to a compression device wearable by a user for applying compression on a left lower limb and a right lower limb of the user. The compression device includes a left massager sleeve, a right massager sleeve, a computing device, a left air pressure hose, and a right air pressure hose. The left massager sleeve and the right massager sleeve are adapted to surround and secure the left lower limb, and the right lower limb respectively. The computing device generates air pressure. The computing device includes a control panel to control the flow of the air pressure in the left massager sleeve and the right massager sleeve. The computing device includes a battery to provide power supply to the control panel. The left air pressure hose supplies air pressure to the left massager sleeve. The right air pressure hose supplies air pressure to the right massager sleeve.

### FIELD OF THE INVENTION

The present invention relates to a compression device, and more particularly to a rechargeable and portable compression device wearable by a user for applying compression on a left lower limb and a right lower limb of the user.

### BACKGROUND

Typically, compression devices or clothes for applying compression to a selected area of a user's anatomy are used in many situations. For example, compression devices are used to treat venous insufficiency or edema, or to recover muscle or to provide improved blood flow, or to prevent deep vein thrombosis (DVT). Such a compression device according to the preamble is also known from the US patent U.S. Ser. No. 10/772,790B2 issued to Wild, et al.

Wild, et al. further describe a compression device for the limb of a mobile patient. The device includes an inflatable sleeve adapted to surround the limb; a conduit attached to the sleeve for delivering fluid to the sleeve; and a portable, wearable controller attached to the conduit that generates and controls the flow of fluid in the device.

Also known is an apparatus for providing compression and vibration therapy from US patent US20210275390A1 filed by Hsueh; Yu-Chi; et al. Hsueh; Yu-Chi; et al. discloses an apparatus for providing compression and vibration therapy to a body part can include a housing, a pump positioned in the housing, the pump configured to generate air pressure, a compression sleeve configured to at least partially surround the body part, the compression sleeve can include an inflatable chamber in fluid communication with the pump and can be configured to apply pressure to the body part in response to receiving air from the pump, and a vibrating unit configured to apply vibration to the body part.

US patent US20210275386A1 filed by Ravikumar; Sundaram; et al. describes a therapeutic compression apparatus for providing pressure to a limb or other body part including a bladder assembly having at least one bladder within a primary wrap and/or a secondary wrap. The primary wrap includes an inflation port to connect to an inflation means which provides either constant or varying pressure within the bladder and a check valve is included in the inflation port and/or inflation means.

These known devices do not provide mobility features during the usage of the compression device and further do not provide various compression modes. Further, the existing compression devices have various disadvantages such as the sleeves being inflatable and not user-friendly. The sleeves are wrapped around the limb and the bladder are inflated by a controller that resides separately from the user. If the user must move, the sleeve must be removed. In addition, while the sleeve is on the user, the tubes connecting the bladder and controller may become entangled with the user's limbs. Furthermore, the compression device must be used while connected to a power supply.

The present invention aims to resolve at least some of the problems and disadvantages mentioned above. The aim of the invention is to provide a compression device and method that eliminates those disadvantages. The present invention targets at solving at least one of the aforementioned disadvantages.

The invention thereto aims to provide a compression device wearable by a user for applying compression on a left lower limb and a right lower limb and providing power supply to the compression device through a battery attached with the compression device.

There remains a need in the art for an improved, rechargeable, and portable compression device.

Accordingly, a need arises for a rechargeable, portable, and full-leg air compression massager to alleviate pain and accelerate recovery.

### SUMMARY OF THE INVENTION

The present invention and embodiments thereof serve to provide a solution to one or more of the above-mentioned disadvantages. To this end, the present invention relates to a compression device wearable by a user for applying compression on a left lower limb and a right lower limb of the user and providing the power supply to the compression device through a battery.

According to an embodiment herein, the compression device includes a left massager sleeve, a right massager sleeve, a computing device, a left air pressure hose, and a right air pressure hose. The left massager sleeve is adapted to surround the left lower limb. The left massager sleeve includes a first zipper to secure left foot and left calf of the user. The left massager further includes a first hook and loop fastener to secure left thigh of the user. The right massager sleeve is adapted to surround the right lower limb. The right massager sleeve includes a second zipper to secure right foot and right calf of the user. The right massager further includes a second hook and loop fastener to secure right thigh of the user. The computing device generates air pressure. The computing device includes a control panel and a battery. The control panel is adapted to control the flow of the air pressure in the left massager sleeve and the right massager sleeve. The battery is adapted to provide power supply to the control panel, wherein the battery is operably connected to the control panel to provide usage of the compression device without being connected with a power supply. The left air pressure hose supplies air pressure to the left massager sleeve in response to receiving air pressure from the computing device. The left air pressure hose is operably connected to the left massager sleeve to apply the air pressure to the left lower limb. The right air pressure hose supplies air pressure to the right massager sleeve in response to receiving air pressure from the computing device. The right air pressure hose is operably connected to the right massager sleeve to apply the air pressure to the right lower limb.

In another embodiment, the computing device includes a display screen to display a timer, a compression intensity, a battery status, and a plurality of massage modes.

In another embodiment, the battery status indicates a battery level of remaining power available in the battery.

In another embodiment, the computing device comprises a timer button to set the timer of usage to the compression device upon receiving a press gesture from the user.

In another embodiment, the computing device includes an intensity button to start and stop an operation of the computing device and to adjust one or more air pressure levels upon receiving a press gesture from the user.

In another embodiment, the computing device includes a first massage mode button to initiate a first command pertaining to massage the foot, calf, and thigh of the user upon receiving a press gesture from the user.

In another embodiment, the computing device includes a second massage mode button to initiate a second command pertaining to simultaneously massage at least two of the foot, calf, and thigh of the user upon receiving a press gesture from the user.

In another embodiment, the computing device includes a third massage mode button to initiate a third command pertaining to separately massage either the foot, calf, or thigh of the user upon receiving a press gesture from the user.

In another embodiment, the computing device includes a memory to store a plurality of instructions pertaining to the one or more air pressure levels, the first command, the second command, the third command, and the battery levels; and a processor to execute the plurality of instructions stored in the memory.

In another embodiment, the left air pressure hose, and the right air pressure hose are inserted into the computing device to supply the air pressure.

In another embodiment, the compression device includes an adapter and an extension cord to charge the battery of the computing device.

In another embodiment, the compression device is placed in a carry bag to provide portability when the compression device is not in use.

In a second aspect, the present invention relates to a method for applying compression on a left lower limb and a right lower limb. The method includes a step of providing power supply to a computing device using a battery. The method includes generating air pressure using the computing device. The method includes a step of controlling the air pressure through a control panel of the computing device. The method includes a step of supplying air pressure using a left air pressure hose to a left massager sleeve and using a right air pressure hose to a right massager sleeve in response to receiving air pressure from the computing device. The method includes a step of surrounding the left lower limb by a left massager sleeve and the right lower limb by a right massager sleeve and applying air pressure to the left lower limb and the right lower limb. The method includes a step of displaying a timer, a compression intensity, a battery status, and a plurality of massage modes through a display screen configured within the computing device. The method includes a step of starting and stopping an operation of the computing device and adjusting one or more air pressure levels upon receiving a press gesture from the user through an intensity button present on the computing device. The method includes the step of charging the battery using an adapter and an extension cord. The method includes the step of plugging a first end of the adapter into a power outlet and a second end of the adapter into a charging port of the control unit to charge the battery. The method includes the step of operating the compression device while the charging of the battery.

In another embodiment, the one or more air pressure levels having a predefined pressure value stored in a memory of the computing device.

In another embodiment, the one or more air pressure levels comprises a first air pressure level, a second air pressure level, a third air pressure level, and a fourth air pressure level.

In another embodiment, the predefined pressure value for the first air pressure level is about 10 KPa.

In another embodiment, the predefined pressure value for the second air pressure level is about 15 KPa.

In another embodiment, the predefined pressure value for the third air pressure level is about 20 KPa.

In another embodiment, the predefined pressure value for the fourth air pressure level is about 25 KPa.

In another embodiment, the battery is charged for at least two hours.

### DESCRIPTION OF FIGURES

The following description of the figures of specific embodiments of the invention is merely exemplary in nature and is not intended to limit the present teachings, their application, or their uses. Throughout the drawings, corresponding reference numerals indicate like or corresponding parts and features.

FIG. 1 shows a schematic representation of a compression device wearable by a user for applying compression on a left lower limb and a right lower limb of the user of an embodiment of the present invention.

FIG. 2 shows a schematic view of the left massager sleeve and the right massager sleeve of an embodiment of the present invention.

FIG. 3 shows a schematic inner view of the left massager sleeve and the right massager sleeve of an embodiment of the present invention.

FIG. 4 shows a first schematic front view of the left massager sleeve and the right massager sleeve of an embodiment of the present invention.

FIG. 5 shows a second schematic front view of the left massager sleeve and the right massager sleeve of an embodiment of the present invention.

FIG. 6 shows a schematic top view of the left massager sleeve and the right massager sleeve of an embodiment of the present invention.

FIG. 7 shows a schematic side view of the right massager sleeve of an embodiment of the present invention.

FIG. 8 shows a schematic view of a thigh portion of the left massager sleeve and the right massager sleeve of an embodiment of the present invention.

FIG. 9 shows a schematic side view of the left massager sleeve of an embodiment of the present invention.

FIG. 10 shows an exploded view of the computing device of an embodiment of the present invention.

FIG. 11 shows a flowchart of a method for applying compression on a left lower limb and a right lower limb of the user of an embodiment of the present invention.

### DETAILED DESCRIPTION OF THE INVENTION

The present invention concerns a compression device wearable by a user for applying compression on a left lower limb and a right lower limb and heat on a left knee and a right knee of the user.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specify the presence of what follows e.g. component and do not exclude or preclude the presence of additional, non-recited components, features, element, members, steps, known in the art or disclosed therein.

Furthermore, the terms first, second, third, and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any 3, 4, 5, 6 or 7, etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures, or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention and form different embodiments, as would be understood by those in the art. For example, in the following claims, any of the claimed embodiments can be used in any combination.

In a first aspect, the invention provides/relates to a compression device wearable by a user for applying compression on a left lower limb and a right lower limb of the user. The compression device includes a left massager sleeve, a right massager sleeve, a computing device, a left air pressure hose, and a right air pressure hose. The computing device includes a control unit and a battery.

The inventors have unexpectedly observed that the present invention provides a portable professional-grade full-leg air compression massager with 3 modes and 4 airbags in 3 zones to provide muscle recovery, pain relief, decrease inflammation, better blood flow, and ensure a thorough relaxation experience. Further, the compression device of the present invention provides a full-Leg massage that covers the thighs, knees, calves, and feet of the user. Furthermore, the compression device of the present invention provides flexibility to the user to use the compression device without continuous plugged in into the power supply.

In a preferred embodiment of the invention, the computing device includes a battery attached with the computing device to supply power to the computing device without external power supply.

In a particularly preferred embodiment, the computing device has various configurations to enable the user to find a massage mode that fits the user best.

In another preferred embodiment, the left massager sleeve, and the right massager sleeve include zippers and adjustable fasteners to ensure that the sleeves fit the users irrespective of their limb's size.

In a preferred embodiment, the compression device is operable with an uncharged or partly charged battery while being connected with a power supply. Preferably the compression device is operable with an uncharged or partly charged battery while being connected with a power supply and while charging the battery.

However, it is obvious that the invention is not limited to this application. The method according to the invention can be applied in all sorts of wearable compression devices, massager, and rechargeable therapy devices.

The invention is further described by the following non-limiting figures which further illustrate the invention, and are not intended to, nor should they be interpreted to, limit the scope of the invention.

### DESCRIPTION OF FIGURES

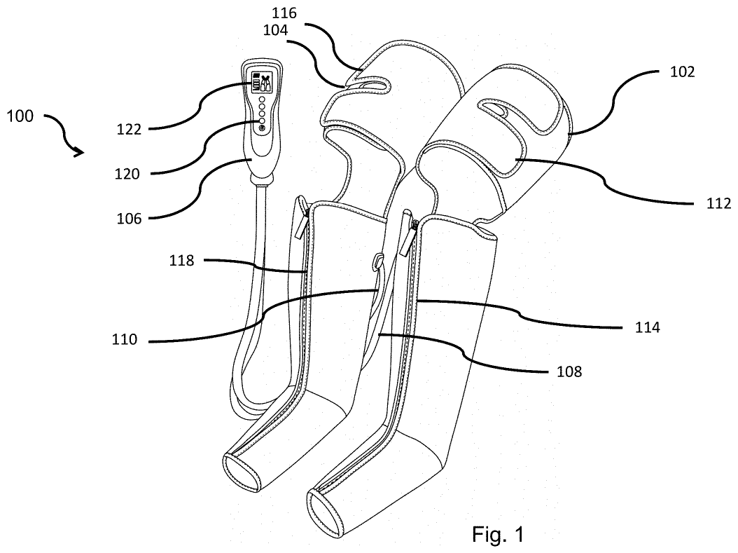

FIG. 1 shows a schematic representation of a compression device 100 wearable by a user for applying compression on a left lower limb and a right lower limb of the user of an embodiment of the present invention. The compression device 100 includes a left massager sleeve 102, a right massager sleeve 104, a computing device 106, a left air pressure hose 108, and a right air pressure hose 110. The left massager sleeve 102 is adapted to surround the left lower limb. The right massager sleeve 104 is adapted to surround the right lower limb. The computing device 106 generates air pressure. The left air pressure hose 108 supplies air pressure to the left massager sleeve 102 in response to receiving air pressure from the computing device 106. The left air pressure hose 108 is operably connected to the left massager sleeve 102 to apply the air pressure to the left lower limb. The left massager sleeve 102 includes a first hook and loop fastener 112 to secure the left thigh of the user. The left massager sleeve 102 further includes a first zipper 114 to secure left foot and left calf of the user. The right massager sleeve 104 includes a second hook and loop fastener 116 to secure the right thigh of the user. The right massager sleeve 102 further includes a second zipper 118 to secure right foot and right calf of the user. The first hook and loop fasteners 112 and the second hook and loop fasteners 116 are adjustable fasteners to ensure that the left massager sleeve 102, and the right massager sleeve 104 fit the users irrespective of their size. The right air pressure hose 110 is operably connected to the right massager sleeve 104 to apply the air pressure to the right lower limb. The right air pressure hose 110 supplies air pressure to the right massager sleeve 104 in response to receiving air pressure from the computing device 106. In another embodiment, the left air pressure hose 108, and the right air pressure hose 110 are inserted into the computing device 106 to supply the air pressure. The computing device 106 includes control panel 120 and a display screen 122. The control panel 120 controls the flow of the air pressure. the display screen 122 displays a timer, a compression intensity, a battery status, and a plurality of massage modes. In another embodiment, the compression device 100 includes an adapter and an extension cord to recharge the computing device 106. In another embodiment, the compression device 100 is placed in a carry bag when not in use to provide portability.

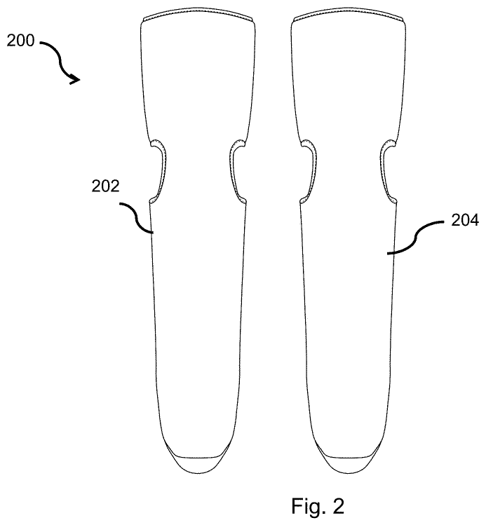

FIG. 2 shows a schematic view 200 of the left massager sleeve and the right massager sleeve of an embodiment of the present invention. According to an embodiment herein, the compression device includes a left massager sleeve 202 to surround the left lower limb and a right massager sleeve 204 to surround the right lower limb.

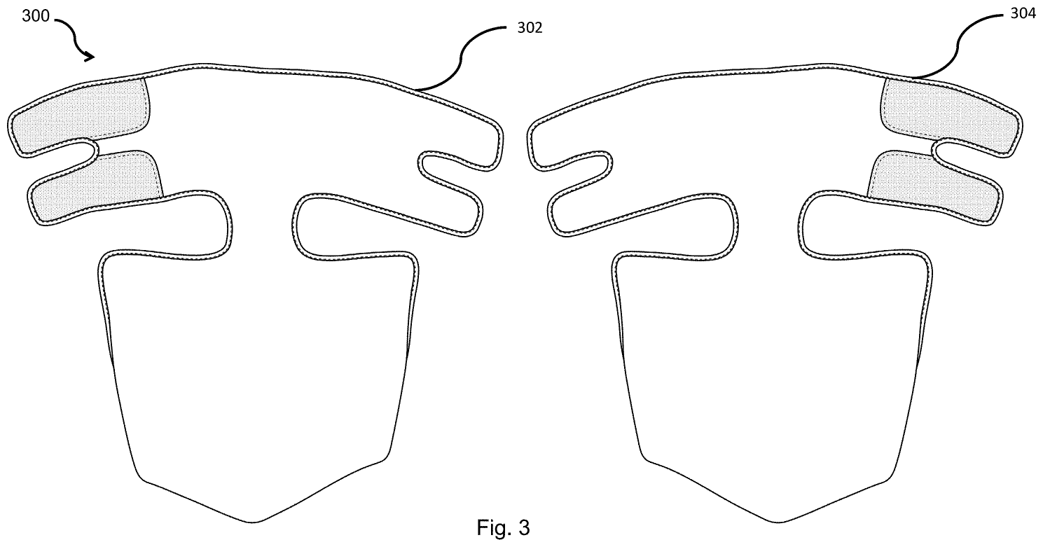

FIG. 3 shows a schematic inner view 300 of the left massager sleeve, and the right massager sleeve of an embodiment of the present invention. According to an embodiment herein, the left massager sleeve includes a left thigh portion 302 to cover the left thigh of the user, and the right massager sleeve includes a right thigh portion 304 to cover the right thigh of the user.

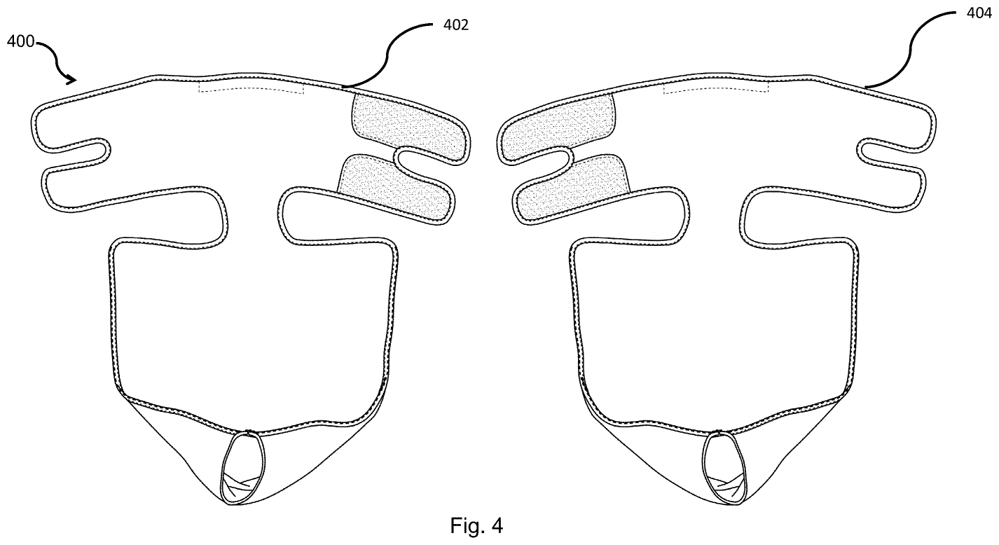

FIG. 4 shows a first schematic front view 400 of the left massager sleeve and the right massager sleeve of an embodiment of the present invention. In an embodiment, the left massager sleeve 402 and the right massager sleeve 404 act as a massager that provides compression massage to the user and reduces inflammation, and interrupts pain signals. The first schematic front view 400 illustrates the left massager sleeve 402 and the right massager sleeve 404 when user is not wearing the compression device.

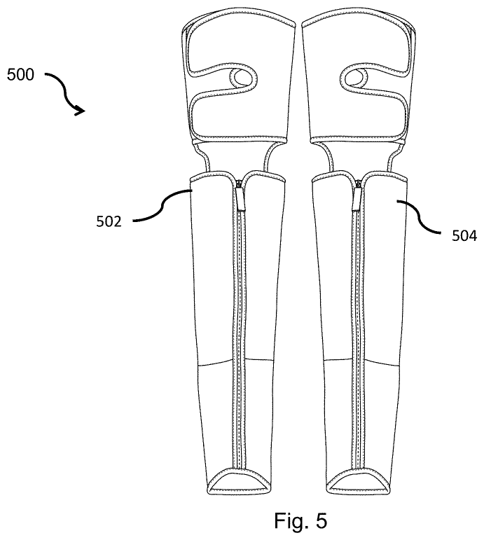

FIG. 5 shows a second schematic front view 500 of the left massager sleeve and the right massager sleeve of an embodiment of the present invention. In an embodiment, the left massager sleeve 502 and the right massager sleeve 504 act as a massager that provides compression massage to the user and reduces inflammation, and interrupts pain signals. The first schematic front view 500 illustrates the left massager sleeve 502 and the right massager sleeve 504 when user is wearing the compression device.

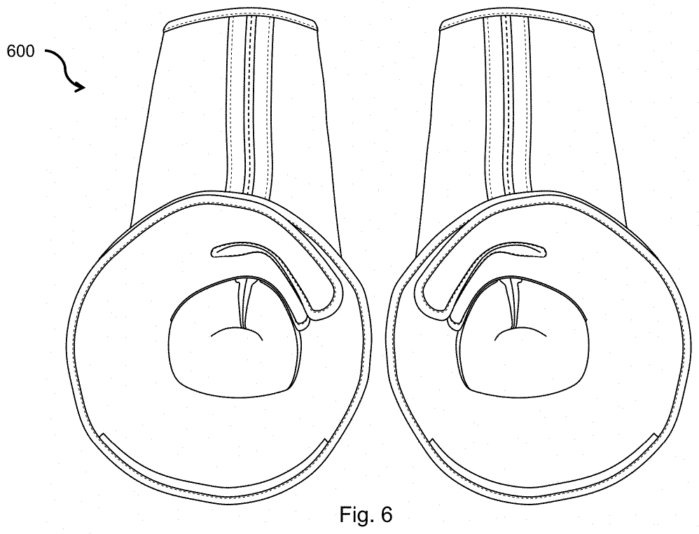

FIG. 6 shows a schematic top view 600 of the left massager sleeve, and the right massager sleeve of an embodiment of the present invention. According to an embodiment herein, the left massager sleeve 102 covers the left thigh, the left foot and the left calf of the user and the right massager sleeve 104 covers the right thigh, the right foot and the right calf of the user.

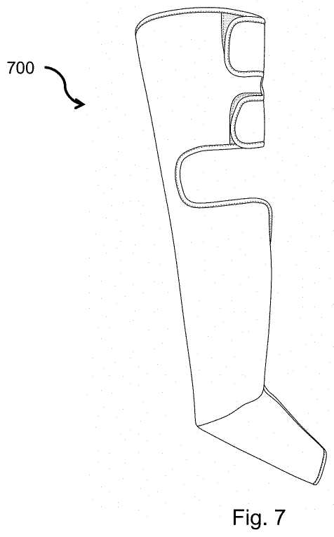

FIG. 7 shows a schematic side view 700 of the right massager sleeve of an embodiment of the present invention. In an embodiment, the right massager sleeve provides full cover to the right lower limb of the user that will gently help the user to rest and recover at the end of a long day.

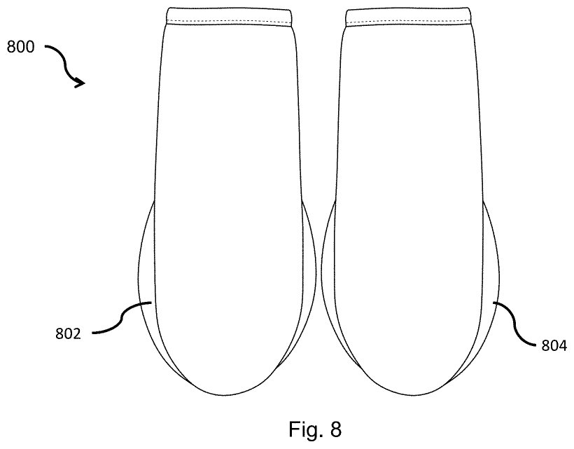

FIG. 8 shows a schematic view 800 of a thigh portion of the left massager sleeve, and the right massager sleeve of an embodiment of the present invention. According to an embodiment herein, the left massager sleeve includes a left thigh portion 802, and the right massager sleeve includes a right thigh portion 804 to cover the thigh of the user.

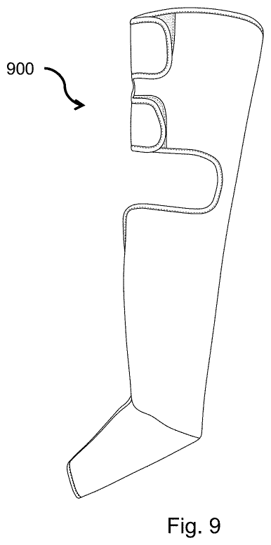

FIG. 9 shows a schematic side view 900 of the left massager sleeve of an embodiment of the present invention. In an embodiment, the left massager sleeve provides full cover to the left lower limb of the user that will gently help the user to rest and recover at the end of a long day.

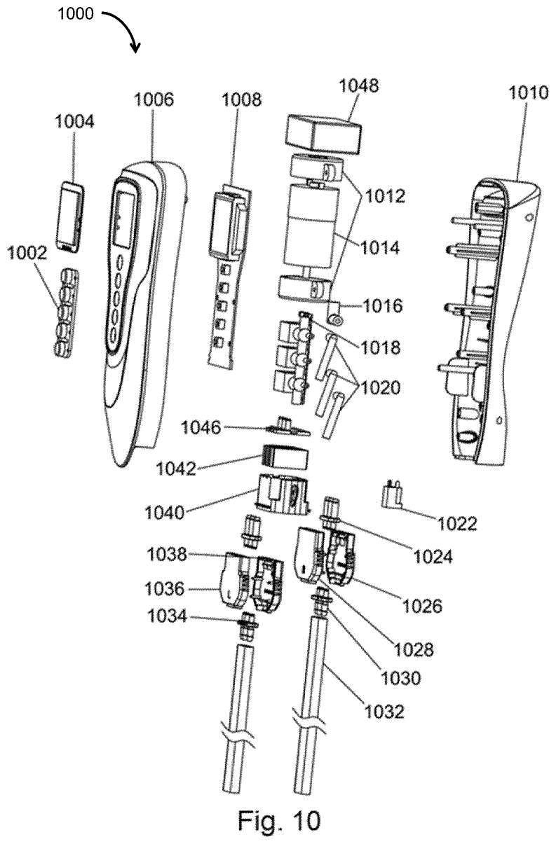

FIG. 10 shows an exploded view 1000 of the computing device of an embodiment of the present invention. FIG. 10 is explained in conjunction with FIG. 1. According to an embodiment herein, the computing device 106 includes various components such as silicone keys 1002, a mirror 1004, hand control cover 1006, hand control panel semi-finished product 1008, heat control lower cover 1010, rubber cover 1012, air pump 1014, silicone cover (air pump) 1016, triple air valve 1018, trachea 1020, DC seat 1022, tee 1024, R trachea transfer to the lower shell 1026, R trachea transfer to the upper shell 1028, R cross 1030, quadruple trachea 1032, L cross 1034, L trachea transfer to the top 1036, L trachea transfer lower shell 1038, hand controller 1040, silicone transfer 1042, and battery 1048. In an embodiment, the computing device 106 acts as a remote controller for the compression device. In an embodiment, the silicone keys 1002 include a first massage mode button, a second massage mode button, a third massage mode button, and an intensity button. According to an embodiment herein, the silicone keys 1002 are made of silicon, mirror 1004 is made of glass, the display is an LCD screen made of glass, rubber cover 1012 is made of nitrile butadiene rubber (NBR), and air pump 1014 is made of steel, copper wire, POM, and rubber. According to an embodiment herein, the triple air valve 1018 is made of steel, nylon, and glass fiber. In an embodiment, the upper cover and lower cover of the sleeves are made of Acrylonitrile butadiene styrene (ABS). In an embodiment, the computing device includes silicon elbow pipe (air valve) and air pipe that are made of silicon. In an embodiment, the computing device includes a baseboard that is made of ABS. In an embodiment, the silicone transfer 1046 is made of silicon. In an embodiment, the computing device includes a main transferring part, a lower cover of transferring part, a lower cover of transferring part, the lower cover of transferring part for R air pipes, and upper cover of transferring part for L air pipes are made of ABS. In an embodiment, the compression device includes an L four-way, three-way, and R four-way are made of POM. Further, DC seat 1024 and DC port are made of cold-rolled sheet and nylon and glass fiber. Further, the four lines of air pipes of the sleeves are made of PVC. The tube parts of the hoses are made of PVC and UL2468 #22AWG*2C. The thigh airbag left airbag, and the right airbag is made of TPU and Nylon 210D. The sleeve cover is made of Black 200D Nylon (polyamide).

The computing device 106 includes a control panel 120 to control the flow of the air pressure in the left massager sleeve 102 and the right massager sleeve 104. In another embodiment, the computing device 106 includes a display screen 122 to display a timer, a compression intensity, a battery status, and a plurality of massage modes such as a first massage mode (Mode 1), second massage mode (Mode 2), and the third massage mode (Mode 3). The following table 1 depicts the working part of the body in various massage modes.

TABLE 1

Working part

| | | | |
|---|---|---|---|
| Mode | Feet | Calves | Thighs |

| | | | | |
|---|---|---|---|---|
| Mode1 | 1 | 1 | 1 | 1 |
| Mode2 | 1 | 1 | 1 | |
| | 2 | | 1 | 1 |
| | 3 | 1 | | 1 |
| Mode3 | 1 | 1 | | |
| | 2 | | 1 | |
| | 3 | | | 1 |

The first massage mode button initiates a first command pertaining to simultaneously massage each of the foot, calf, and thigh of the user upon receiving a press gesture from the user. The second massage mode button initiates a second command pertaining to simultaneously massage at least two of the foot, calf, and thigh of the user upon receiving a press gesture from the user. In an embodiment, the user can press the second massage mode button to select one of three sub-modes of Mode 2 (see Table 1), wherein in a first sub-mode Mode 2-1 feet and calves are simultaneously massaged, wherein in a second sub-mode Mode 2-2 calves and thighs are simultaneously massaged and wherein in a third sub-mode Mode 2-3 feet and thighs are simultaneously massaged. The third massage mode button initiates a third command pertaining to separately massage either the foot, calf, or thigh of the user upon receiving a press gesture from the user. In an embodiment, the user can press the third massage mode button to select one of three sub-modes of Mode 3 (see Table 1), wherein in a first sub-mode Mode 3-1 only feet are massaged, wherein in a second sub-mode Mode 3-2 only calves are massaged and wherein in a third sub-mode Mode 3-3 only thighs are massaged. The intensity button starts and stops an operation of the computing device and adjusts one or more air pressure levels upon receiving a press gesture from the user. In an embodiment, the user can press the intensity button to adjust the intensity (from Level 1 to Level 4). Further, the user can press the intensity button for at least 3 seconds to turn off the operation of the computing device. The following table 2 depicts the set pressure value for each level.

TABLE 2
The set pressure value for each level

| | |
|---|---|
| Level 1 | 10 KPa |
| Level 2 | 15 KPa |
| Level 3 | 20 KPa |
| Level 4 | 25 KPa |

Deviation: ±3 KPa
There is no absolute correspondence between the air pressure value of each air bag and the time during the working process; the program only controls the air pressure value of the key control node, and the air pressure value during the inflation process is not used as a control parameter.

The computing device 106 includes a memory to store a plurality of instructions pertaining to the one or more air pressure levels, the first command, the second command, the third command, the fourth command, and the one or more heating levels, and control parameter. Further, the computing device includes a processor to execute the plurality of instructions or software programs stored in the memory. The instructions related to each massage mode are stored in the memory and executed by the processor as per the following tables 3-9 upon receiving the press gesture from the user.

TABLE 3
Mode1

| Step | Situation | Feet | Calves | Thighs |
|---|---|---|---|---|
| 1 | P50 | C | | |
| 2 | P50 | C | C | |
| 3 | PF | C | C | C |
| 4 | 5 | R | R | R |
| 5 | 2.5 | | | |
| 6 | PF | C | | |
| 7 | PF | C | C | |
| 8 | PF | c | C | C |
| 9 | 5 | R | R | R |
| 10 | 4 | | | |
| 11 | PF | | | C |
| 12 | PF | | C | C |
| 13 | PF | C | C | C |
| 14 | 5 | R | R | R |
| 15 | 2.5 | | | |
| 16 | PF | C | C | C |
| 17 | 5 | R | R | R |
| 18 | 10 | | | |

TABLE 4
Mode2-1

| Step | Situation | Feet | Calves | Thighs |
|---|---|---|---|---|
| 1 | P50 | C | | |
| 2 | PF | C | C | |
| 3 | 5 | R | R | |
| 4 | 2.5 | | | |
| 5 | PF | C | | |
| 6 | PF | C | C | |
| 7 | 5 | R | R | |
| 8 | 2.5 | | | |
| 9 | PF | | C | |
| 10 | PF | C | C | |
| 11 | 5 | R | R | |
| 12 | 2.5 | | | |
| 13 | PF | C | C | |
| 14 | 5 | R | R | |
| 15 | 8 | | | |

TABLE 5
Mode2-2

| Step | Situation | Feet | Calves | Thighs |
|---|---|---|---|---|
| 1 | P50 | | C | |
| 2 | PF | | C | C |
| 3 | 5 | | R | R |
| 4 | 2.5 | | | |
| 5 | PF | | C | |
| 6 | PF | | C | C |
| 7 | 5 | | R | R |
| 8 | 4 | | | |
| 9 | PF | | | C |
| 10 | PF | | C | C |
| 11 | 5 | | R | R |
| 12 | 2.5 | | | |
| 13 | PF | | C | C |
| 14 | 5 | | R | R |
| 15 | 10 | | | |

TABLE 6
Mode2-3

| Step | Situation | Feet | Calves | Thighs |
|---|---|---|---|---|
| 1 | P50 | C | | |
| 2 | PF | C | | C |
| 3 | 5 | R | | R |
| 4 | 2.5 | | | |
| 5 | PF | C | | |
| 6 | PF | C | | C |
| 7 | 5 | R | | R |
| 8 | 4 | | | |
| 9 | PF | | | C |
| 10 | PF | C | | C |
| 11 | 5 | R | | R |
| 12 | 2.5 | | | |
| 13 | PF | C | | C |
| 14 | 5 | R | | R |
| 15 | 10 | | | |

TABLE 7
Mode3-1

| Step | Situation | Feet | Calves | Thighs |
|---|---|---|---|---|
| 1 | PF | C | | |
| 2 | 5 | R | | |
| 3 | P90 | | | |
| 4 | PF | C | | |
| 5 | 5 | R | | |
| 6 | P80 | | | |
| 7 | PF | C | | |
| 8 | 5 | R | | |
| 9 | P70 | | | |
| 10 | PF | C | | |
| 11 | 5 | R | | |
| 12 | P60 | | | |
| 13 | P70 | C | | |
| 14 | 5 | R | | |
| 15 | P60 | | | |
| 16 | P80 | C | | |
| 17 | 5 | R | | |
| 18 | 0.1 | | | |
| 19 | P90 | C | | |
| 20 | 5 | R | | |
| 21 | P80 | | | |
| 22 | PF | C | | |
| 23 | 5 | R | | |
| 24 | P90 | | | |
| 25 | PF | C | | |
| 26 | 5 | R | | |
| 27 | 3 | | | |

TABLE 8
Mode3-2

| Step | Situation | Feet | Calves | Thighs |
|---|---|---|---|---|
| 1 | PF | | C | |
| 2 | 5 | | R | |
| 3 | P90 | | | |
| 4 | PF | | C | |
| 5 | 5 | | R | |
| 6 | P80 | | | |
| 7 | PF | | C | |
| 8 | 5 | | R | |
| 9 | P70 | | | |
| 10 | PF | | C | |
| 11 | 5 | | R | |
| 12 | P60 | | | |
| 13 | P70 | | C | |
| 14 | 5 | | R | |
| 15 | P60 | | | |
| 16 | P80 | | C | |
| 17 | 5 | | R | |
| 18 | 0.1 | | | |
| 19 | P90 | | C | |
| 20 | 5 | | R | |
| 21 | P80 | | | |
| 22 | PF | | C | |
| 23 | 5 | | R | |
| 24 | P90 | | | |
| 25 | PF | | C | |
| 26 | 5 | | R | |
| 27 | 3 | | | |

TABLE 9
Mode3-3

| Step | Situation | Feet | Calves | Thighs |
|---|---|---|---|---|
| 1 | PF | | | C |
| 2 | 5 | | | R |
| 3 | P90 | | | |
| 4 | PF | | | C |
| 5 | 5 | | | R |
| 6 | P80 | | | |
| 7 | PF | | | C |
| 8 | 5 | | | R |
| 9 | P70 | | | |
| 10 | PF | | | C |
| 11 | 5 | | | R |
| 12 | P60 | | | |
| 13 | P70 | | | C |
| 14 | 5 | | | R |
| 15 | P60 | | | |
| 16 | P80 | | | C |
| 17 | 5 | | | R |
| 18 | 0.1 | | | |
| 19 | P90 | | | C |
| 20 | 5 | | | R |
| 21 | P80 | | | |
| 22 | PF | | | C |
| 23 | 5 | | | R |
| 24 | P90 | | | |
| 25 | PF | | | C |
| 26 | 5 | | | R |
| 27 | 3 | | | |

In the above tables 3-9, C is indicative of “inflating”, R is indicative of “Keep pressure”, P70 is indicative of “70% of the set pressure value”, P80 is indicative of “80% of the set pressure value”, P90 is indicative of 90% of the set pressure value, PF is indicative of “The set pressure value”, and Figure is indicative of “Executing time (Unit: second, under situation column)”.

According to an embodiment, the computing device 106 includes the battery 1048 to provide power supply to the computing device 106. The battery 1048 is physically attached with the computing device 1048 to provide flexibility to the user to move while wearing the left massager sleeve 102 and the right massager sleeve 104. The battery 1048 may be charged by using the adapter and the extension cord. In an embodiment, the left massager sleeve and the right massager sleeve help the user to recover the muscles, alleviates pain, decrease inflammation, improve blood flow, alleviates foot pain, alleviates chronic pain, combat blood pooling, alleviates restless legs syndrome, alleviates cellulite, alleviates varicosity, trigger points, alleviates soreness, alleviates muscle fatigue, alleviates blood clots, alleviates muscle knots, and alleviates swollen veins. In an embodiment, the compression device helps the user to recover faster after workouts, and the user can relax at the end of a hard day. Further, the left massager sleeve and the right massager sleeve of the compression device provide three airbags to deliver impressive compression leading to truly therapeutic results.

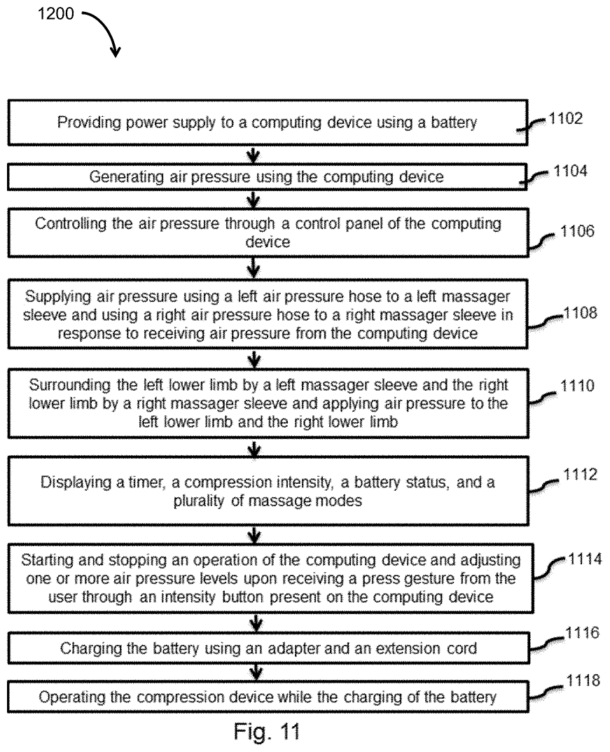

FIG. 11 shows a flowchart 1100 of a method for applying compression on a left lower limb and a right lower limb of the user of an embodiment of the present invention. The method includes a step 1102 of providing power supply to a computing device using a battery. The method includes a step 1104 to generating air pressure using the computing device. The method includes a step 1106 of controlling the air pressure through a control panel of the computing device. The method includes a step 1108 of supplying air pressure using a left air pressure hose to a left massager sleeve and using a right air pressure hose to a right massager sleeve in response to receiving air pressure from the computing device. The method includes a step 1110 of surrounding the left lower limb by a left massager sleeve and the right lower limb by a right massager sleeve and applying air pressure to the left lower limb and the right lower limb. The method includes a step 1112 of displaying a timer, a compression intensity, a battery status, and a plurality of massage modes through a display screen configured within the computing device. The method includes a step 1114 of starting and stopping an operation of the computing device and adjusting one or more air pressure levels upon receiving a press gesture from the user through an intensity button present on the computing device. In another embodiment, the one or more air pressure levels having a predefined pressure value stored in a memory of the computing device. In another embodiment, the one or more air pressure levels comprises a first air pressure level, a second air pressure level, a third air pressure level, and a fourth air pressure level. In another embodiment, the predefined pressure value for the first air pressure level is about 10 KPa. In another embodiment, the predefined pressure value for the second air pressure level is about 15 KPa. In another embodiment, the predefined pressure value for the third air pressure level is about 20 KPa. In another embodiment, the predefined pressure value for the fourth air pressure level is about 25 KPa. The method includes a step 1116 of charging the battery using an adapter and an extension cord. The method includes a step 1118 of operating the compression device while the charging of the battery.

The present invention will now be further exemplified with reference to the following examples. The present invention is in no way limited to the given examples or to the embodiments presented in the figures.

### Example 1

A compression device shown in FIG. 1 is used to deal with tight and sore muscles. The users don't always have a lot of time to sit and soak in a tub. The users just have to strap the sleeves on their legs and let them do the work, while the users get things done on the computer and or catch up on their TV shows. The heat setting feature helps the users from being sore so that the next day the user can go and work out at the highest level they can.

### Example 2

During an experiment, the compression device as shown in FIG. 1 is used by a user to use the compression device while the movement of the user. This feature provides mobility to user while using the compression device provided that the battery of the computing device has been charged properly. The user observes that the compression device is comfortable to put on easy to take off and fits nicely around his wide calves up to his thighs. He wraps it up to his thighs and around his feet then switches the massager on from the handheld control and feels the air circulate. He found the different options for massage levels useful, and he felt the intensity with each mode. It is believed that he found the fabric comfortable and breathable. Additionally, the user can walk in park while using the compression device.

### Example 3

In the experiment of Example 2, it was found that the user used the compression just before bedtime and often fall asleep while it is running. He loves the fact that it automatically shuts off after 30 minutes. The compressions and different settings worked amazingly for him.

It is supposed that the present invention is not restricted to any form of realization described previously and that some modifications can be added to the presented example of fabrication without reappraisal of the appended claims. For example, the present invention has been described as referring to alleviating pain and accelerating recovery, but it is clear that the invention can be applied to heal wounds for instance or to prevent deep vein thrombosis (DVT).

It is clear that the method according to the invention, and its applications, are not limited to the presented examples.

The present invention is in no way limited to the embodiments described in the examples and/or shown in the figures. On the contrary, methods according to the present invention may be realized in many different ways without departing from the scope of the invention.

1. A compression device wearable by a user for applying compression on a left lower limb and a right lower limb, the compression device comprising:
a left massager sleeve adapted to surround the left lower limb, wherein the left massager sleeve comprises a first zipper to secure left foot and left calf of the user, and wherein the left massager further comprises a first hook and loop fastener to secure left thigh of the user;
a right massager sleeve adapted to surround the right lower limb, wherein the right massager sleeve comprises a second zipper to secure right foot and right calf of the user, and wherein the right massager further comprises a second hook and loop fastener to secure right thigh of the user;
a computing device adapted to generate air pressure, wherein the computing device comprises:
a control panel to control a flow of the air pressure in the left massager sleeve and the right massager sleeve; and
a battery to provide power supply to the control panel, wherein the battery is operably connected to the control panel to provide usage of the compression device without being connected with a power supply;
a left air pressure hose adapted to supply air pressure to the left massager sleeve in response to receiving air pressure from the computing device, wherein the left air pressure hose is operably connected to the left massager sleeve to apply the air pressure to the left lower limb; and
a right air pressure hose adapted to supply air pressure to the right massager sleeve in response to receiving air pressure from the computing device, wherein the right air pressure hose is operably connected to the right massager sleeve to apply the air pressure to the right lower limb.

2. The compression device as claimed in claim 1, wherein the computing device comprises a display screen to display a timer, a compression intensity, a battery status, and a plurality of massage modes.

3. The compression device as claimed in claim 2, wherein the battery status indicates a battery level of remaining power available in the battery.

4. The compression device as claimed in claim 1, wherein the computing device comprises a timer button to set the timer of usage to the compression device upon receiving a press gesture from the user.

5. The compression device as claimed in claim 1, wherein the computing device comprises an intensity button to start and stop an operation of the computing device and to adjust one or more air pressure levels upon receiving a press gesture from the user.

6. The compression device as claimed in claim 1, wherein the computing device comprises a first massage mode button to initiate a first command pertaining to simultaneously massage each of the foot, calf, and thigh of the user upon receiving a press gesture from the user.

7. The compression device as claimed in claim 1, wherein the computing device comprises a second massage mode button to initiate a second command pertaining to simultaneously massage at least two of the foot, calf, and thigh of the user upon receiving a press gesture from the user.

8. The compression device as claimed in claim 1, wherein the computing device comprises a third massage mode button to initiate a third command pertaining to separately massage either the foot, calf, or thigh of the user upon receiving a press gesture from the user.

9. The compression device as claimed in claim 1, wherein the computing device comprises:
a memory to store a plurality of instructions pertaining to the one or more air pressure levels, the first command, the second command, the third command, and the battery levels; and
a processor to execute the plurality of instructions stored in the memory.

10. The compression device as claimed in claim 1, wherein the left air pressure hose, and the right air pressure hose are inserted into the computing device to supply the air pressure.

11. The compression device as claimed in claim 1 further comprises an adapter and an extension cord to charge the battery of the computing device.

12. The compression device as claimed in claim 1 is placed in a carry bag to provide portability when the compression device is not in use.

13. The compression device as claimed in claim 1, wherein the compression device is operable with an uncharged or partly charged battery while being connected with a power supply.

14. A method implemented by a compression device for applying compression on a left lower limb and a right lower limb of the user, the method comprising:
providing power supply to a computing device using a battery;
generating air pressure using the computing device;
controlling the air pressure through a control panel of the computing device;
supplying air pressure using a left air pressure hose to a left massager sleeve and using a right air pressure hose to a right massager sleeve in response to receiving air pressure from the computing device; and
surrounding the left lower limb by a left massager sleeve and the right lower limb by a right massager sleeve and applying air pressure to the left lower limb and the right lower limb.

15. The method as claimed in claim 14 comprises a step of displaying a timer, a compression intensity, a battery status, and a plurality of massage modes through a display screen configured within the computing device.

16. The method as claimed in claim 14 comprises a step of starting and stopping an operation of the computing device and adjusting one or more air pressure levels upon receiving a press gesture from the user through an intensity button present on the computing device.

17. The method as claimed in claim 16, wherein the one or more air pressure levels having a predefined pressure value stored in a memory of the computing device.

18. The method as claimed in claim 16, wherein the one or more air pressure levels comprises a first air pressure level, a second air pressure level, a third air pressure level, and a fourth air pressure level.

19. The method as claimed in claim 17, wherein the predefined pressure value for the first air pressure level is about 10 KPa.

20. The method as claimed in claim 17, wherein the predefined pressure value for the second air pressure level is about 15 KPa.

21. The method as claimed in claim 17, wherein the predefined pressure value for the third air pressure level is about 20 KPa.

22. The method as claimed in claim 17, wherein the predefined pressure value for the fourth air pressure level is about 25 KPa.

23. The method as claimed in claim 14 comprises a step of charging the battery using an adapter and an extension cord.

24. The method as claimed in claim 23 comprises plugging a first end of the adapter into a power outlet and a second end of the adapter into a charging port of the control unit to charge the battery.

25. The method as claimed in claim 24, wherein the battery is charged for at least two hours.

26. The method as claimed in claim 25 comprises operating the compression device while the charging of the battery.
